(19) United States
(12) Patent Application Publication
(10) Pub. No.: US 2010/0096159 A1
(43) Pub. Date: Apr. 22, 2010

(54) METHOD OF MANUFACTURING A FOAM-INSULATED WIRE USING A POROUS SOLID AND A FOAM-INSULATED WIRE MANUFACTURED THEREBY

(75) Inventors: Tomiya ABE, Hitachi (JP); Yoshihisa KATO, Hitachi (JP)

Correspondence Address: MATTINGLY & MALUR, P.C., 1800 DIAGONAL ROAD, SUITE 370, ALEXANDRIA, VA, 22314, US

(73) Assignee: HITACHI CABLE, LTD., Tokyo (JP)

(21) Appl. No.: 12/427,066

(22) Filed: Apr. 21, 2009

(30) Foreign Application Priority Data
Oct. 17, 2008 (JP) 2008-268656

(51) Int. Cl. H01B 3/00; B05D 5/12

(52) U.S. Cl. 174/110 F; 427/119

(57) ABSTRACT

A method of manufacturing a foam-insulated wire, which uses a porous solid, which is able to improve performance of a foam-insulated wire by controlling the dispersion of the void content of the insulation, and the foam-insulated wire manufactured thereby are provided. The method comprising the steps of: forming a film of coating on the conductor with a water-in-oil form emulsion (O/W-form emulsion); curing the oil layer in the film of coating of the water-in-oil form emulsion by polymerization; removing water droplets therefrom; and thereby forming an insulation layer of a porous solid on the conductor.

### TECHNICAL FIELD

The present invention relates to an insulated electrical wire, and particularly relates to a method of manufacturing a foam-insulated wire using a porous solid and a foam-insulated wire manufactured thereby.

### BACKGROUND ART

In information equipment, its technology keeps on progressing for higher signal transmission speed. Such high-speed signal transmission uses a foam-insulated wire having a foamed insulation layer provided by a foaming-extrusion of polyethylene or fluorine resin, from a viewpoint that places a greater importance on the lower dielectric constant.

Downsizing and densifying in such equipment, which recently shows more intensified development, comes to demand a wire having a conductor of 0.3 mm or smaller in diameter for example. However, manufacturing a foam-insulated wire on this fine-size order by the foaming-extrusion encounters a technical difficulty. As a measure for overcoming the difficulty, a method, which manufactures a foam-insulated wire by coating ultraviolet curable resin containing gas or foaming agent on the conductor followed by ultraviolet curing process, has been proposed as shown in JP3047686B, JP1995-278333A, JP1995-272662A, JP1995-272663A, JP1995-335053A, JP1996-17256A, JP1996-17257A, JP1995-320506A, JP1997-102230A, JP1999-176262A and JP1999-297142A.

This method can be valued highly in that the manufacturing speed is high and that the foamed insulation layer is efficiently provided. The method however involves a disadvantage in that manufacturing a wire thereby easily causes the wire to have a dispersion or variation in the void content (a degree of foaming consisting of air-bubbles defined as the ratio of the volume of air-bubbles to the volume of resin in an insulation layer). This comes from the fact that the method forms the insulation layer while allowing air-bubbles to grow. Therefore, controlling the degree of foam growth during manufacturing processing is hardly practicable. If dispersion in the void content of the insulation on a wire occurs, it causes a variation of the dielectric constant of the insulation connecting to a fluctuation of transmission performances of the wire, or a cable, resulting in a signal delay in transmission.

To solve this problem, another arts that provide fine foam have been proposed in JP2004-2812A, JP3963765B and WO2004/048064.

According to the proposed art, the dispersion in the void content of the insulation can be controlled by making the foam fine.

The method disclosed in JP2004-2812A is however not applicable to forming the insulation of wires or cables. The method uses a polymer that includes such a chemical as decomposes by a light irradiation to form fine foams, but producing acid. This acid corrodes metallic components, i.e., conductors; therefore, the method is not applicable.

The methods disclosed in JP2004-2812A and JP3963765B are also not applicable to manufacturing wires and cables. The methods are for manufacturing porous films, wherein the porous film is obtained by removing organic solvent under a moistened condition while manufacturing a cast film. This method is time-consuming processing, which is therefore rather questionable in application to manufacturing wires and cables.

### SUMMARY OF THE INVENTION

The present provides a method of manufacturing a foam-insulated wire, which uses a porous solid, and the foam-insulated wire manufactured thereby, which solves above-stated problems and improves performance of a foam-insulated wire, particularly a fine-diameter wire for a signal handling device, having a porous-foamed insulation layer by controlling the dispersion of the void content (a degree of foaming consisting of air-bubbles defined as the ratio of the volume of air-bubbles to the volume of resin in an insulation layer) of an insulation with the production efficiency maintained at the equivalent degree in the conventional one.

According to a first aspect of the present invention, a method of manufacturing a foam-insulated wire is provided with a porous solid insulation layer on a conductor comprises the steps of:

forming a film of coating on the conductor using a water-in-oil form emulsion (O/W-form emulsion);

curing the oil layer in the film of coating of the water-in-oil form emulsion by polymerization;

removing water droplets therefrom; and

thereby forming an insulation layer of a porous solid on the conductor.

According to a second aspect of the present invention, the method of manufacturing a foam-insulated wire is provided with a porous solid insulation layer on a conductor according to the first aspect of the present invention, wherein the water-in-oil form emulsion (O/W-form emulsion) includes less than 40 parts by weight of water to 100 parts by weight of oil component.

According to a third aspect of the present invention, the method of manufacturing a foam-insulated wire is provided with a porous solid insulation layer on a conductor according to the first aspect or the second aspect of the present invention, wherein the conductor is selected from a conductor having an outer diameter of 0.3 mm or smaller and a stranded conductor of seven conductors each having an outer diameter of 30 μm or smaller.

According to a fourth aspect of the present invention, the method of manufacturing a foam-insulated wire is provided with a porous solid insulation layer on a conductor according to any one of the first aspect to the third aspect of the present invention, wherein the oil layer in the water-in-oil form emulsion is a precursor of an ultraviolet curable resin, which is cured by polymerization after being formed into the film of coating.

According to a fifth aspect of the present invention, the method of manufacturing a foam-insulated wire is provided with a porous solid insulation layer on a conductor according to any one of the first aspect to the fourth aspect of the present invention, wherein the water-in-oil form emulsion includes a surfactant.

According to a sixth aspect of the present invention, a foam-insulated wire is manufactured by a manufacturing method according to any one of the first aspect to the fifth aspect of the present invention.

According to the present invention, a wire manufacturing method will be given a remarkably high productivity in manufacturing foam-insulated wires of high void content with homogeneous foam distribution even the insulation thickness of the wire is to be very thin. This is an excellent contribution to the wire industry.

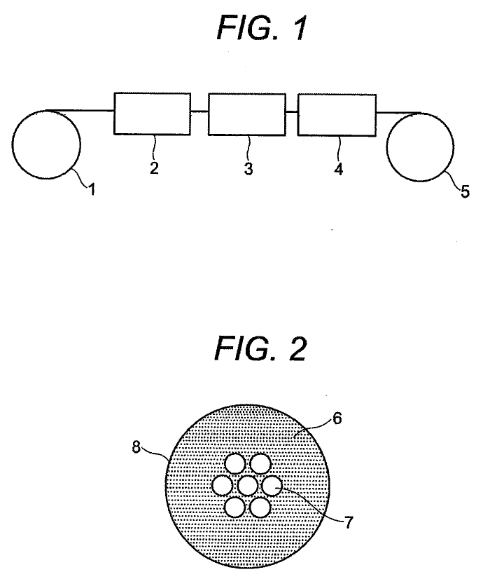

### BRIEF DESCRIPTION OF DRAWINGS

[FIG. 1] An illustration of a coating-curing-drying apparatus for manufacturing a foam-insulated wire of the present invention

[FIG. 2] A sectional view of a foam-insulated wire of the present invention

### DESCRIPTION OF EMBODIMENTS

The following explains an example of preferred embodiments of the present invention.

In the present invention, it is practicable to use a thermal curing solventless liquid varnish as the precursor of the ultraviolet curable resin that forms the oil layer of the water-in-oil form emulsion (W/O-form emulsion), wherein the basic configuration of the varnish includes a polymerizing oligomer, a polymerizing monomer, and a curing initiator.

Polymerizing oligomers in the present invention include such a polymerizing oligomer as has two or more functional groups having unsaturated bonds such as, for example, acryloyl group, methacryloyl group, acrylic group, and vinyl group. These groups may include fluorine substitutions for a part of their constituent elements.

Examples of such oligomers include: epoxy acrylate-based oligomer, epoxidized oil acrylate-based oligomer, urethane acrylate-based oligomer, polyester urethane acrylate-based oligomer, polyether urethane acrylate-based oligomer, polyester acrylate-based oligomer, polyether acrylate-based oligomer, vinyl acrylate-based oligomer, silicone acrylate-based, polybutadien acrylate-based oligomer, polystyrene ethyl methacrylate-based oligomer, polycarbonate dicarbonate-based oligomer, unsaturated polyester-based oligomer, and polyene/thiol-based oligomer.

Each of these oligomers can be used alone or in a blend with other items.

Polymerizing monomers in the present invention include such a polymerizing monomer as has two or more radicals selected from such as acryloyl group, methacryloyl group, acrylic group,.vinyl group, and other similar groups.

The curing initiator in the present invention functions in such a manner that it decomposes by light producing free radicals, which start curing the polymerizing oligomer and the polymerizing monomer. Curing initiators having such function include: benzoin ether-based chemicals, ketal-based chemicals, asetophenon-based chemicals, benzophenon-based chemicals, and other similar chemicals.

In the present invention, below-listed compounds additionally to the above-stated substances can be also used where necessary.

Usable compounds include: initiator auxiliary, adhesion inhibitor, thixotropy-giving agent, filler, plasticizer, unreactive polymer, colorant, flame retardant, flame retardant auxiliary, softening inhibitor, mold release, desiccant, dispersant, wetter, precipitation inhibitor, -thickener, antistat, static-stopper, fungicide, rodenticide, ant repellent, delusterant, blocking inhibitor, anti-skinning agent, surfactant and other similar compounds.

An ultraviolet irradiation source in the present invention includes a low-pressure mercury lamp and a metal halide lamp.

A surfactant that can be added as an emulsifier is categorized into two major groups. One is an ionic surfactant that electrolytically dissociates into ions (charged atoms or a group of charged atoms) when dissolved in water; and the other is a nonionic (nonion) surfactant that does not ionize. The ionic surfactant is further classified into an anionic (anion) surfactant, a cationic (cation) surfactant, and ampholytic surfactant.

In the present invention, it is preferable to use the nonionic surfactant because insulation material for wires and cables is required to have a higher electrical insulation property.

The nonionic surfactant is further classified into an ester type, an ether type, and an ester-ether type according to their configuration. The present invention does not have any specific classification-related requirement in selection of nonionic surfactant; however, examples of usable surfactant suitable for the present invention includes following types of substances.

As the ester type surfactant, glycerin fatty acid ester, sorbitan fatty acid ester, and sucrose fatty acid ester are typical example.

As the ether type surfactant, an addition-polymerized substance, which is produced by the addition-polymerization applied to a material having hydroxyl group such as higher alcohol or alkylphenol, can be an example of this type.

As the ester-ether type surfactant, ethylene oxide-added fatty acid and ethylene oxide-added polyhydric alcohol fatty acid ester, which have both the ester bond and the ether bond in their molecules, can be examples of usable substances.

Fluorine-based surfactant and silicone-based surfactant can be also listed.

A surfactant has a parameter, the hydrophile-lipophile balance (HLB), which represents a degree of hydrophilicity and hydrophobicity thereof. In the present invention, it is essential to prepare the O/W-form emulsion in which water droplets are dispersed in oil. As a general preference in the present invention therefore, the surfactant to be used should have a low HLB. In this regard, a surfactant having an HBL of five or lower will bring a highly beneficial effect. As for the usage of the surfactant, it is preferred to use within an amount of 1% or less because of the requirement by insulation properties of wires and cables.

Preparation Method of Emulsion:

The present invention does not limit the method of preparing the O/W-form emulsion to a particular emulsification method. A typical method is the agitation emulsification, wherein a mother material of the O/W-form emulsion, a composition to which UV curing resin prepolymer, water, and surfactant are compounded, is agitated with a high-speed agitator or an ultrasonic agitator to the emulsified state. Another typical method may be the membrane emulsification, wherein the same mother material is passed through a porous film such as a glass filter to become emulsion.

The O/W-form emulsion in the present invention can be prepared by compounding oil component (a precursor of the above-stated ultraviolet curable resin or similar substance) and water into a mother material of the emulsion, which is agitated with a high-speed agitator or ultrasonic agitator, or is passed through a glass filter (membrane emulsification), to form a emulsion. In this treatment, it is preferred to also compound thereinto a surfactant as an emulsifier. Thereby, the O/W-form emulsion in such a configuration that water droplets of water-component exist in an oil layer of above-stated oil component, is prepared.

The size of the water droplet of the water-component is preferred to be as small as possible because a smaller size of droplet produces a smaller size of air-bubble in the insulation. Therefore, it is a technical preference that the water droplet size should be 20 μm or smaller. If the size is over 20 μm, such water droplet causes the size of the air-bubble, which will be produced in the insulation, to be large. The larger size of air-bubble weakens the strength the porous solid with a possible collapse or break.

This O/W-form emulsion is coated on a conductor, and then the coating undergoes ultraviolet curing for polymerization of the oil layer thereof. After curing, water droplets in the cured oil layer are removed by, for example, drying; this removal creates voids of air-bubbles in the portion where the water droplets occupied. Thereby, an insulation layer of porous solid is provided on the conductor.

It is preferable that the O/W-form emulsion in the present invention should include less than 40 parts by weight of water to 100 parts by weight of oil component. The reason for this is as follows. If the content of water in such emulsion is as high as 40 or more parts by weight to 100 parts by weight of oil component, the produced air-bubbles form open-cells (interconnected air-bubbles with their walls broken). Therefore, if the porous solid used as an insulation of a wire and a cable has such open-cells structure, there arises a possibility of maintaining a stable capacitance being hardly practicable, because these open-cells easily collapse or deform when the wire or the cable is pressed or bent while in use. Further, a higher content of water in such emulsion causes a phase transition of the emulsion into an oil-in-water form emulsion depending on conditions. The phase-transformed emulsion may produce beads of resin on the film of coating of the emulsion or may cause resin-film lacking on the coating, while applying the emulsion on the conductor. These deficiencies develop to occurrence of a bare conductor in manufacturing foam-insulated wires, and therefore a stable production of foam-insulated wires becomes not possible.

In the present invention, it is preferable to configure an O/W-form emulsion with the content of less than 40 parts by weight of water to 100 parts by weight of oil component; thereby the produced air-bubbles are assured to be closed-cell with a satisfactory porous solid suitable for an insulation of wires and cables.

The following explains examples of embodiments of the manufacturing method of a foam-insulated wire by the present invention, together with comparison examples.

### Embodiment 1

A composition comprised of:
a) Polymerizable oligomer: 80.0 parts by weight of urethane acrylate-based oligomer;
b) Polymerizable monomer: 20.0 parts by weight of monomer having an acryloyl group;
Curing initiator: 2 parts by weight of 1-hydroxy-cyclohexyl-phenyl-ketone (Irgacure® 184, Ciba Specialty Chemicals Co., Ltd.);
Surfactant: 1 part by weight of sorbitan monoleate (Rheodol® SP-030, Kao corporation); and
Water: 30 parts by weight,
   was agitated with a high-speed agitator (Excel Auto Homogenizer ED-12, Nissei Corporation) at a speed of 10,000 rpm for five minutes to obtain a water-in-oil form emulsion (O/W-form emulsion) having an average water droplet size of 5 μm (measured with SALD-2000A, Shimadzu Corporation).

Using the emulsion thus prepared, an insulated wire was manufactured through a coating-curing-drying apparatus as shown in FIG. 1, wherein the apparatus is comprised of: a wire conductor pay-off unit 1, a coating die 2, an ultraviolet lamp 3 (a metal halide lamp, 1 kW), a dryer 4 (a hot-air blow type, 250° C. of drying-blow for one second), and a wire take-up unit 5 (60 m/min of line speed).

In this manufacturing, the conductor 7 was a seven-strand of bare copper wires, as shown in FIG. 2, each of which was 25 μm in diameter and the thickness of the insulation layer 6 of the foam-insulated wire 8 was 40 μm. An observation of the wire 8 thus manufactured under a scanning electron microscope (SEM) found that 40 percent of the total volume of the insulation layer 6 for 100 meters of the wire 8 was occupied by air-bubbles of average 5 μm in size. The void content was examined by: determining a weight-differential between the weight of a solid insulation layer having the same dimension as the foam-insulated wire 8 and the weight of the foamed insulation layer on the foam-insulated wire 8; and then, calculating the ratio of the weight-differential (which represents the volume of the air-bubble portion) to the weight of the foamed insulation layer on the wire 8.

### Embodiment 2

A composition comprised of:
a) Polymerizable oligomer: 80.0 parts by weight of urethane acrylate-based oligomer;
b) Polymerizable monomer: 20.0 parts by weight of monomer having an acryloyl group;
Curing initiator: 2 parts by weight of 1-hydroxy-cyclohexyl-phenyl-ketone (Irgacure® 184, Ciba Specialty Chemicals Co., Ltd.); and
Water: 20 parts by weight,
   was agitated with a high-speed agitator (Excel Auto Homogenizer ED-12, Nissei Corporation) at a speed of 10,000 rpm for five minutes to obtain a water-in-oil form emulsion (O/W-form emulsion) having an average water droplet size of 15 μm (measured with SALD-2000A, Shimadzu Corporation).

Using the emulsion thus prepared, an insulated wire was manufactured through a coating-curing-drying apparatus as shown in FIG. 1, wherein the apparatus is comprised of: a wire conductor pay-off unit 1, a coating die 2, an ultraviolet lamp 3 (a metal halide lamp, 1 kW), a dryer 4 (a hot-air blow type, 250° C. of drying-blow for one second), and a wire take-up unit 5 (60 m/min of line speed).

In this manufacturing, the conductor 7 was a seven-strand of bare copper wires, each of which was 25 μm in diameter, and the thickness of the insulation layer 6 of the foam-insulated wire 8 was 40 μm. An observation showed that 40-percent of the total volume of the insulation layer 6 for 100 meters of the wire 8 was occupied by air-bubbles of average 15 μm in size. The void content was examined by the same procedure as stated in embodiment 1.

### COMPARATIVE EXAMPLE 1

A composition comprised of:
a) Polymerizable oligomer: 80.0 parts by weight of urethane acrylate-based oligomer;
b) Polymerizable monomer: 20.0 parts by weight of monomer having an acryloyl group; and
Curing initiator: 2 parts by weight of 1-hydroxy-cyclohexyl-phenyl-ketone (Irgacure® 184, Ciba Specialty Chemicals Co., Ltd.),
   was processed into varnish.

Using the varnish thus prepared, an insulated wire was manufactured through a coating-curing-drying apparatus as shown in FIG. 1, wherein the apparatus is comprised of: a wire conductor pay-off unit 1, a coating die 2, an ultraviolet lamp 3 (a metal halide lamp, 1 kW), a dryer 4 (a hot-air blow type, 250° C. of drying-blow for one second), and a wire take-up unit 5 (60 m/min of line speed).

In this manufacturing, the conductor was a seven-strand of bare copper wires, each of which was 25 μm in diameter, and the thickness of the insulation layer of the wire was 40 μm. An observation taught that no foam was found in the insulation layer because the water-in-oil form emulsion had not been used.

### COMPARATIVE EXAMPLE 2

A composition comprised of:
a) Polymerizable oligomer: 80.0 parts by weight of urethane acrylate-based oligomer;
b) Polymerizable monomer: 20.0 parts by weight of monomer having an acryloyl group;
Curing initiator: 2 parts by weight of 1-hydroxy-cyclohexyl-phenyl-ketone (Irgacure® 184, Ciba Specialty Chemicals Co., Ltd.),
Surfactant: 1 part by weight of sorbitan monoleate (Rheodol® SP-030, Kao corporation); and
Water: 200 parts by weight,
   was agitated with a high-speed agitator (Excel Auto Homogenizer ED-12, Nissei Corporation) at a speed of 10,000 rpm for five minutes to obtain a water-in-oil form emulsion (O/W-form emulsion) having an average water droplet size of 10 μm (measured with SALD-2000A, Shimadzu Corporation).

Using the emulsion thus prepared, an insulated wire was manufactured through a coating-curing-drying apparatus as shown in FIG. 1, wherein the apparatus is comprised of: a wire conductor pay-off unit 1, a coating die 2, an ultraviolet lamp 3 (a metal halide lamp, 1 kW), a dryer 4 (a hot-air blow type, 250° C. of drying-blow for one second), and a wire take-up unit 5 (60 m/min of line speed).

In this manufacturing, the conductor was a seven-strand of bare copper wires, each of which was 25 μm in diameter. Despite several attempts in forming the insulation layer, acceptable insulation layer was not obtained but a solid that could narrowly be called a porous solid. What was observed on such insulation layer was large variation or irregularity of the insulation thickness and diameter; further, there was even a lack or discontinuity of insulation with the exposed conductor. These are because of high content of water compared to the oil component. Thus, such product was not usable as a wire or a cable.

In contrast, embodiment examples 1 and 2 were successful in manufacturing foam-insulated wires with the foamed insulation layer of excellent state of air-bubbles rendered by the use of water-in-oil emulsion.

Thus, the water content being less than 40 parts by weight to 100 parts by weight of oil makes foam-insulated wires is manufactured in a satisfactory quality; and it is practicable to obtain insulated wires that are hardly collapsible or deformable against a compression or bending force.

It will be obvious to those having skill in the art that many changes may be made in the above-described details of the preferred embodiments of the present invention. The scope of the present invention, therefore, should be determined by the following claims.

1. A method of manufacturing a foam-insulated wire provided with a porous solid insulation layer on a conductor, said method comprising the steps of:
forming a film of coating on said conductor using a water-in-oil form emulsion (O/W-form emulsion);
curing the oil layer in said film of coating of said water-in-oil form emulsion by polymerization;
removing water droplets therefrom; and
thereby forming an insulation layer of a porous solid on said conductor.

2. The method of manufacturing a foam-insulated wire provided with a porous solid insulation layer on a conductor according to claim 1, wherein said water-in-oil form emulsion (O/W-form emulsion) includes less than 40 parts by weight of water to 100 parts by weight of oil component.

3. The method of manufacturing a foam-insulated wire provided with a porous solid insulation layer on a conductor according to claim 1, wherein said conductor is selected from a conductor having an outer diameter of 0.3 mm or smaller and a stranded conductor of seven conductors each having an outer diameter of 30 μm or smaller.

4. The method of manufacturing a foam-insulated wire provided with a porous solid insulation layer on a conductor according to claim 1, wherein said oil layer in said water-in-oil form emulsion is a precursor of an ultraviolet curable resin, which is cured by polymerization after being formed into said film of coating.

5. The method of manufacturing a foam-insulated wire provided with a porous solid insulation layer on a conductor according to claim 3, wherein said oil layer in said water-in-oil form emulsion is a precursor of an ultraviolet curable resin, which is cured by polymerization after being formed into said film of coating.

6. The method of manufacturing a foam-insulated wire provided with a porous solid insulation layer on a conductor according to claim 1, wherein said water-in-oil form emulsion includes a surfactant.

7. The method of manufacturing a foam-insulated wire provided with a porous solid insulation layer on a conductor according to claim 3, wherein said water-in-oil form emulsion includes a surfactant.

8. The method of manufacturing a foam-insulated wire provided with a porous solid insulation layer on a conductor according to claim 4, wherein said water-in-oil form emulsion includes a surfactant.

9. The method of manufacturing a foam-insulated wire provided with a porous solid insulation layer on a conductor according to claim 5, wherein said water-in-oil form emulsion includes a surfactant.

10. A foam-insulated wire manufactured by a manufacturing method according to claim 1.

11. A foam-insulated wire manufactured by a manufacturing method according to claim 3.

12. A foam-insulated wire manufactured by a manufacturing method according to claim 4.

13. A foam-insulated wire manufactured by a manufacturing method according to claim 5.

14. A foam-insulated wire manufactured by a manufacturing method according to claim 6.

15. A foam-insulated wire manufactured by a manufacturing method according to claim 7.
